(19) United States
(12) Patent Application Publication
(10) Pub. No.: US 2026/0177106 A1
(43) Pub. Date: Jun. 25, 2026

(54) BEARING RING AND ROLLING BEARING

(71) Applicant: Schaeffler Technologies AG & Co. KG, Herzogenaurach (DE)

(72) Inventors: Hua Huo, Shanghai (CN); Weihua Wang, Shanghai (CN); Tao Cheng, Shanghai (CN); Dechun Si, Shanghai (CN)

(21) Appl. No.: 19/121,378

(22) PCT Filed: Oct. 17, 2022
(86) PCT No.: PCT/CN2022/125674

§ 371 Date: Apr. 15, 2025

(51) Int. Cl. F16C 33/58; F16C 19/06

(52) U.S. Cl. CPC F16C 33/583; F16C 19/06

(57) ABSTRACT

A bearing ring of a rolling bearing may include ring sections, connecting pieces, and bolts. The bearing ring sections may be assembled in an annular shape, and each bearing ring section may include a connecting portion located on an axial end face of the bearing ring section and adjacent to a circumferential end face of the bearing ring section, and a fixing hole located on the connecting portion. Each connecting piece may comprise multiple through holes. When the bearing ring sections are assembled, each connecting piece is arranged on adjacent connecting portions of two adjacent bearing ring sections, such that the through holes of the connecting piece respectively correspond to the fixing holes. Each bolt may be inserted into the through hole of each connecting piece and the corresponding fixing hole of each bearing ring section to connect the bearing ring sections to each other.

### CROSS-REFERENCE TO RELATED APPLICATION

The present application is the U.S. National Phase of PCT Patent Application Number PCT/CN2022/125674, filed on Oct. 17, 2022, the entire disclosure of which is incorporated by reference herein.

### TECHNICAL FIELD

The present application relates to a rolling bearing. More particularly, the present application relates to a bearing ring for a rolling bearing.

### BACKGROUND

In the mining, cement or other industries, when large equipment such as a hoist or a belt conveyor is shut down for maintenance due to bearing damage, it is time-consuming to disassemble the old bearing and replace it with a new one, causing a great loss due to production shutdown. If a split bearing is used, the maintenance time required for disassembly and replacement may be reduced.

The split bearing includes a bearing inner ring split in half, and a bearing outer ring split in half. For example, it is possible to cut each of the inner and outer rings of a bearing with a non-split structure into two parts. The two parts of the outer ring may be connected by bolts directly at the split positions. However, the two parts of the inner ring cannot be connected and fixed directly by bolts. In an existing fixing method, the axial width of the inner ring of the bearing may be widened, so that the inner ring is wider than the outer ring and may be locked by a locking ring at the widened portion thereof. In this case, the split bearing can maintain the load carrying capacity to a large extent but has a limited scope of application since it is necessary to modify the surrounding structure due to the inner ring being wider than the outer ring, compared with the bearing with the non-split structure. In another existing fixing method, the size of the rolling element in the split bearing may be reduced to realize the connection and fixing of the split parts of the inner ring, without changing the width of the inner ring with respect to the bearing with the non-split structure. In this case, the load carrying capacity and service life of the split bearing are significantly reduced, compared with the bearing with the non-split structure.

Thus, it is desired to provide a rolling bearing and a bearing ring having a split structure, which can improve the connection performance.

### SUMMARY

An object of the present application is to provide a rolling bearing and a bearing ring for a rolling bearing having a split structure, which can improve the connection performance. Another object of the present application is to provide a rolling bearing and a bearing ring having a split structure, which can balance size and load carrying capacity. A further object of the present application is to provide a rolling bearing and a bearing ring having a split structure, which do not change the axial width of the bearing. A yet further object of the present application is to provide a rolling bearing and a bearing ring having a split structure, which can maintain the load carrying capacity of the bearing.

In an aspect of the present application, there is provided a bearing ring, including multiple bearing ring sections, multiple connecting pieces, and multiple bolts. The multiple bearing ring sections are configured to be connected into a ring. Each bearing ring section includes: connecting portions located on an axial end surface of the bearing ring section and adjacent to circumferential end surfaces of the bearing ring section; and at least one fixing hole located at each connecting portion and extending from the connecting portion. Each connecting piece includes multiple through holes. Each connecting piece is configured to be arranged on the adjacent connecting portions of two adjacent bearing ring sections when the multiple bearing ring sections are assembled, so that the multiple through holes of the connecting piece correspond to the fixing holes of the two adjacent bearing ring sections. Each through hole and the corresponding fixing hole extend obliquely with respect to an axial direction of the bearing ring, and each bolt is configured to be inserted into one through hole of the connecting piece and the corresponding fixing hole of the bearing ring sections, thereby connecting the multiple bearing ring sections to each other. Thus, a bearing ring with a split structure is provided according to the embodiments of the present application, in which the bearing ring sections are connected and fixed by the connecting pieces and bolts on the axial end surface of the bearing ring. Therefore, the bearing ring with the split structure according to the embodiments of the present application may be assembled or disassembled rapidly without sacrificing load carrying capacity. By designing the fixing hole of the bearing ring section to be inclined with respect to the axial direction of the bearing ring, the bolt can be obliquely inserted into the fixing hole, and can provide better anti-shear performance when the inner ring sections are connected.

According to some embodiments of the present application, each connecting portion of each bearing ring section is implemented as a connecting groove recessed from the axial end surface of the bearing ring section, and each connecting piece is configured to be arranged in the contiguous connecting grooves of the two adjacent bearing ring sections. By arranging the connecting piece in the recessed connecting grooves, the bearing ring with the split structure according to the embodiments of the present application may be assembled or disassembled rapidly without increasing the width of the bearing ring, thereby providing a wider range of installation applicability.

According to some embodiments of the present application, each fixing hole of the bearing ring section is configured to extend obliquely from the corresponding connecting groove in a direction taking it gradually away from the corresponding circumferential end surface of the bearing ring section. By configuring the fixing holes at the adjacent connecting grooves of the two connected bearing ring sections to extend obliquely in the direction taking them gradually away from the circumferential end surfaces of the bearing ring sections, the bolts arranged in the fixing holes can provide a larger pretightening force when the bearing ring sections are connected.

According to some embodiments of the present application, each connecting groove of the bearing ring section is arc-shaped, and each connecting piece is arc-shaped. By designing the connecting grooves and the connecting pieces in the arc shape, more bolts may be arranged at the adjacent connecting grooves of the two bearing ring sections, thereby reducing requirements for selecting the bolts.

According to some embodiments of the present application, the bearing ring further includes a locking pin configured to be connected to the bolt. The connecting piece includes a locking groove communicated with the through hole thereof, and the locking pin is configured such that, when the bolt connected with the locking pin is inserted into one through hole of the connecting piece and the corresponding fixing holes of the bearing ring sections, at least one locking pin is bent and at least partially received in the locking groove of the connecting piece. By providing a locking structure including the locking pin, the bolt may be prevented from loosening and thereby affecting the installation and operation of the inner ring after the inner ring sections of the inner ring are assembled.

According to some embodiments of the present application, the bolt includes a mounting groove located on a head of the bolt and extending in an axial direction of the bolt, and the locking pin is configured to be detachably connected in the mounting groove of the bolt. By providing the mounting groove for the locking pin on the head of the bolt, the locking pin may be detachably connected to realize fast installation and disassembly.

According to some embodiments of the present application, the mounting groove and the locking pin have wedge shapes matched with each other, and the wedge shape of the mounting groove is configured to prevent the locking pin from moving away from the connecting piece in the axial direction of the bolt. By using the wedge-shaped locking pin and locking groove, the locking pin can be easily installed, improving the installation efficiency.

According to some embodiments of the present application, the bearing ring includes two bearing ring sections and two connecting pieces.

In another aspect of the present application, there is provided a rolling bearing, including the bearing ring according to the embodiments of the present application.

According to some embodiments of the present application, the bearing ring is an inner ring of the rolling bearing.

### BRIEF DESCRIPTION OF THE DRAWINGS

FIG. 1 is a schematic view of a rolling bearing according to some embodiments of the present application.

FIG. 2 is a schematic view of a bearing ring according to some embodiments of the present application.

FIG. 3 is a schematic top view of a bearing ring according to some embodiments of the present application.

FIG. 4 is a schematic partial enlarged view of a part A in FIG. 2.

FIG. 5 is a schematic section view taken along a line B-B in FIG. 2.

FIG. 6 is a schematic view of a connecting piece according to some embodiments of the present application.

FIG. 7 is a schematic section view taken along a line D-D in FIG. 6.

FIG. 8 is a schematic partial enlarged view of a part C in FIG. 6.

FIG. 9 is a schematic side view of a bolt according to some embodiments of the present application.

FIG. 10 is a schematic bottom view of a bolt according to some embodiments of the present application.

FIG. 11 is a schematic view of a locking pin according to some embodiments of the present application.

FIG. 12 is a schematic view of a part of an inner ring according to some embodiments of the present application.

FIG. 13 is a schematic view of a bolt and a locking pin according to some embodiments of the present application.

### DETAILED DESCRIPTION OF THE EMBODIMENTS

Hereinafter, embodiments of the present application will be described with reference to the accompanying drawings. The following detailed description and the accompanying drawings are used to exemplarily illustrate the principle of the present application. The present application is not limited to the preferred embodiments as described, and the scope of the present application shall be defined by the claims. The present application is now described in detail by means of the exemplary embodiments, some of which are illustrated in the accompanying drawings. The following description is made with reference to the accompanying drawings, and the same reference numerals in different accompanying drawings indicate the same or similar elements unless otherwise indicated. The solutions described below in the exemplary embodiments do not represent all solutions of the present application. Rather, these solutions are merely examples of systems and methods in various aspects of the present application, which are involved in the attached claims.

There is provided a rolling bearing and a bearing ring having a split structure. The exemplary embodiments of the present application will be described below with reference to the accompanying drawings. It should be noted that only some of the embodiments of the present application are shown in the accompanying drawings and that the scope of the present application shall be determined according to the claims.

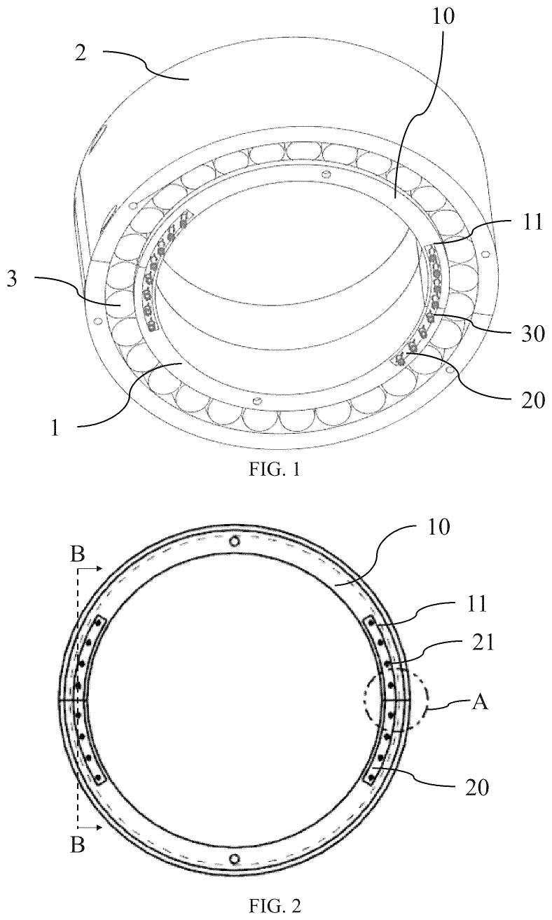

FIG. 1 is a schematic view of a rolling bearing according to some embodiments of the present application. As shown in FIG. 1, the rolling bearing includes an inner ring 1, an outer ring 2, and multiple rolling elements 3. The outer ring 2 may include a radial inner raceway located on its radial inner surface. The inner ring 1 may include a radial outer raceway located on its radial outer surface. The rolling elements 3 may roll between the radial inner raceway and the radial outer raceway. Exemplarily, the inner ring 1 has a split structure according to the embodiments of the present application, which is to say that it serves as the bearing ring claimed in the present application. However, the present application is not limited thereto. The outer ring 2 may also have a split structure according to the embodiments of the present application, which is to say that it serves as the bearing ring claimed in the present application. If the outer ring 2 adopts a split structure, it may be connected and fixed by the connection method provided according to the present application, or by any other existing connection method. For example, the two parts of the outer ring may be directly connected and fixed by bolts on the radial outer side of the outer ring.

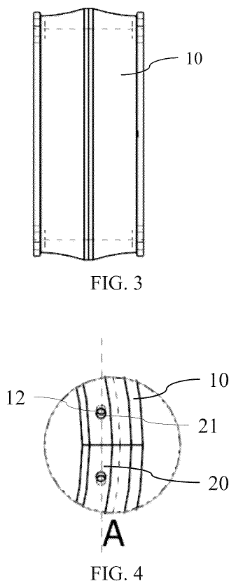

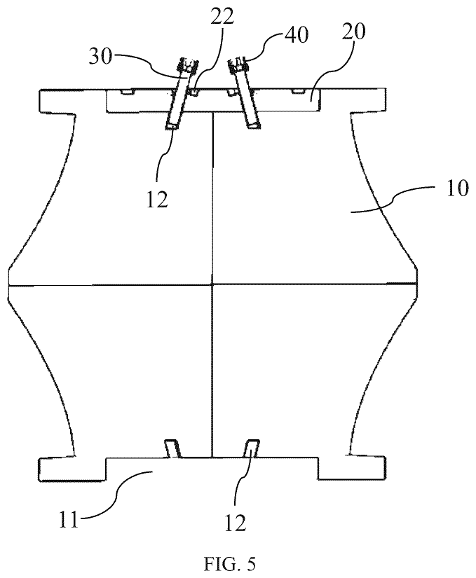

FIG. 2 is a schematic view of a bearing ring according to some embodiments of the present application. FIG. 3 is a schematic top view of a bearing ring according to some embodiments of the present application. FIG. 4 is a schematic partial enlarged view of a part A in FIG. 2. FIG. 5 is a schematic section view taken along a line B-B in FIG. 2.

According to some embodiments of the present application, as shown in FIG. 2, the inner ring 1 includes two inner ring sections 10. Exemplarily, the inner ring sections 10 may each serve as the bearing ring section claimed in the present application. The two inner ring sections 10 may be assembled into a ring. Each inner ring section 10 is in an approximate arc shape when viewed in its axial direction, as shown in FIG. 2. Each inner ring section 10 has two circumferential end surfaces and two axial end surfaces. When two inner ring sections 10 are assembled into a ring, their circumferential end surfaces face each other respectively. In some embodiments, the inner ring sections 10 may be formed from a complete annular inner ring by cutting, for example. In an exemplary embodiment, multiple inner ring sections 10 have the same shape. However, the present application is not limited thereto. In some embodiments, multiple inner ring sections 10 may have different shapes, e.g., different radians or the like when viewed in the axial direction of the inner ring sections. In this specification, the axial direction of the inner ring is the same as that of the inner ring section, and the circumferential direction of the inner ring is the same as the circumferential direction of the inner ring section.

According to some embodiments of the present application, the inner ring section 10 includes a connecting portion located on its axial end surface and adjacent to its circumferential end surface. The connecting portion is configured to connect the inner ring sections 10. In an exemplary embodiment, the connecting portion of the inner ring sections 10 is implemented as a connecting groove 11. The connecting groove 11 is recessed from the axial end surface of the inner ring section 10. In some embodiments, the inner ring section 10 is provided with two connecting grooves 11 on its axial end surface, preferably on each axial end surface. The two connecting grooves 11 may be spaced apart in the circumferential direction of the inner ring section 10 and adjacent to the circumferential end surfaces of the inner ring section 10 respectively. In an exemplary embodiment, when viewed in the axial direction of the inner ring section 10, the connecting groove 11 is arc-shaped.

According to some embodiments of the present application, the inner ring section 10 further includes one or more fixing holes 12 located in the connecting groove 11 and extending from the connecting groove 11. In some embodiments, the inner ring section 10 includes multiple fixing holes 12 which are spaced apart and distributed evenly. In some embodiments, the inner ring section 10 includes multiple fixing holes 12 which are spaced apart and distributed in an arc when viewed in the axial direction of the inner ring section 10. In some embodiments, when the two inner ring sections 10 are assembled to each other, the adjacent fixing holes 12 of the two inner ring sections 10 are spaced apart and distributed in an arc.

According to some embodiments of the present application, as shown in FIG. 2, the inner ring 1 further includes two connecting pieces 20 and multiple bolts 30 to connect and fix the inner ring sections 10.

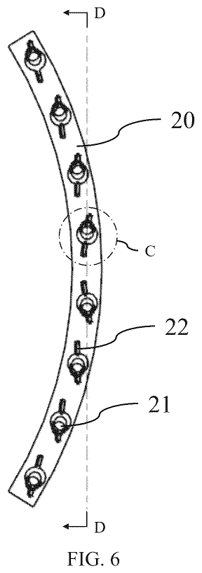

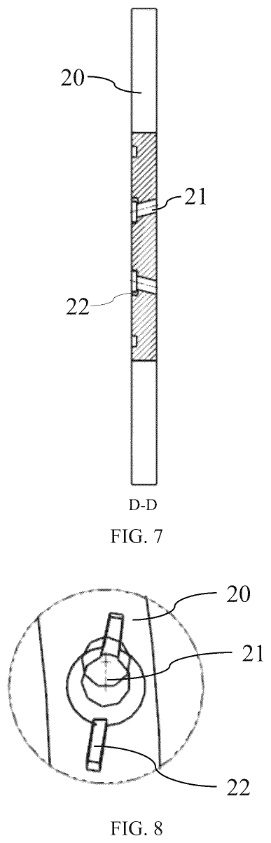

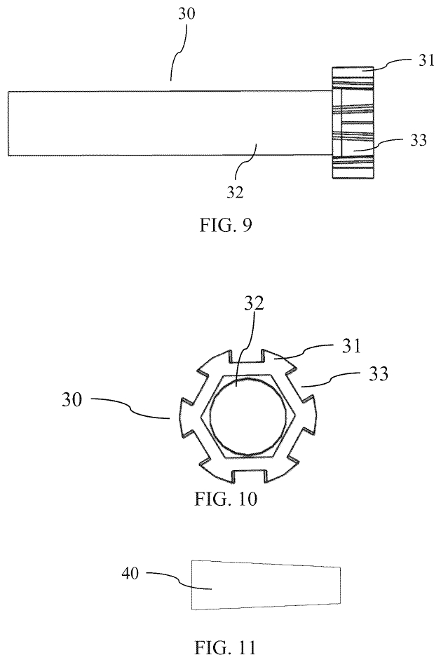

FIG. 6 is a schematic view of a connecting piece according to some embodiments of the present application. FIG. 7 is a schematic section view taken along a line D-D in FIG. 6. FIG. 8 is a schematic partial enlarged view of a part C in FIG. 7. FIG. 9 is a schematic side view of a bolt according to some embodiments of the present application. FIG. 10 is a schematic bottom view of a bolt according to some embodiments of the present application.

In an exemplary embodiment, the connecting piece 20 is arc-shaped, i.e., has an approximate arc shape, as shown in FIG. 7. In some embodiments, the bolt 30 includes a head 31 and a stem portion 32, as shown in FIG. 9. When the two inner ring sections 10 are assembled to each other as shown in FIGS. 2 and 5, each connecting piece 20 may be placed in the contiguous connecting grooves 11 of the two inner ring sections 10.

According to some embodiments of the present application, the connecting piece 20 includes multiple through holes 21, as shown in FIG. 6. When the two inner ring sections 10 are assembled to each other and each connecting piece 20 is placed in the two contiguous connecting grooves 11, the multiple through holes 21 of the connecting piece 20 respectively correspond to the fixing holes 12 of the two inner ring sections 10 when viewed in the axial direction of the inner ring 1, as shown in FIG. 5. As such, the bolt 30 may be inserted into the through hole 21 of the connecting piece 20 and the fixing hole 12 of the inner ring section 10 in sequence. The size and number of the fixing holes 12 and the through holes 21 may be determined according to the size, type, etc. of the bearing. When two inner ring sections 10 are assembled to each other, multiple bolts 30 can connect one connecting piece 20 to the two inner ring sections 10 at the contiguous connecting grooves 11 (i.e., one connection position) of the two inner ring sections 10, as shown in FIG. 1. When two inner ring sections 10 are respectively connected at two connection positions by two connecting pieces 20 and multiple bolts 30, the inner ring 1 is connected and fixed.

By designing the connecting grooves 11 and the connecting pieces 20 in the arc shape, more bolts 30 may be arranged at the adjacent connecting grooves 11 of the two inner ring sections 10, thereby reducing requirements for selecting the bolts. By distributing the multiple fixing holes 12 in an arc, the force applied to the multiple bolts 30 may be more uniform, thereby increasing the service life and pretightening force of the inner ring 1. The diameter and length of the bolt 30 may be determined according to the size, type, etc. of the bearing.

In some embodiments, there is a predetermined clearance between the adjacent circumferential end surfaces of the two connected inner ring sections 10 of the inner ring 1. In some embodiments, a ferrule may be used to restrain the inner ring sections 10 from the radial outer side such that the predetermined clearance exists between the adjacent circumferential end surfaces of the inner ring sections 10, and then the connecting pieces 20 and bolts 30 may be used to connect and fix the inner ring sections 10 to each other. By providing the predetermined clearance between the adjacent circumferential end surfaces of the inner ring sections 10 of the inner ring 1, a pretightening force may be provided in the inner ring 1 to achieve an interference fit with a component such as a shaft.

In an exemplary embodiment, the fixing hole 12 and the corresponding through hole 21 are configured to extend obliquely with respect to the axial direction of the inner ring 1. By designing the fixing hole 12 of the inner ring section 10 and the through hole 21 of the connecting piece 20 to be angled with respect to the axial direction of the inner ring 1, the bolt 30 may be obliquely inserted into the through hole 21 and the fixing hole 12, providing better anti-shear performance when the inner ring sections 10 are connected. In some embodiments, as shown in FIG. 5, the fixing hole 12 extends obliquely from the connecting groove 11 in a direction taking it gradually away from the circumferential end surface of the inner ring section 10. In this case, as shown in FIG. 7, the through hole 21 extends obliquely from the surface of the connecting piece 20 facing away from the connecting groove 11 in a direction taking it gradually away from the circumferential end surface of the inner ring section 10. As a result, at the contiguous connecting grooves 11 of the two inner ring sections 10, the bolt 30 located on one of the inner ring sections 10 is inclined towards the other of the inner ring sections 10, that is, the head 31 of the bolt 30 located on one of the inner ring sections 10 is closer to the other of the inner ring sections 10 than the stem portion 32 of the bolt 30, and vice versa. Thus, the bolt 30 may provide a larger pretightening force when the inner ring sections 10 are connected. The inclination angle of the fixing hole 12 may be determined according to the size, type, etc. of the bearing.

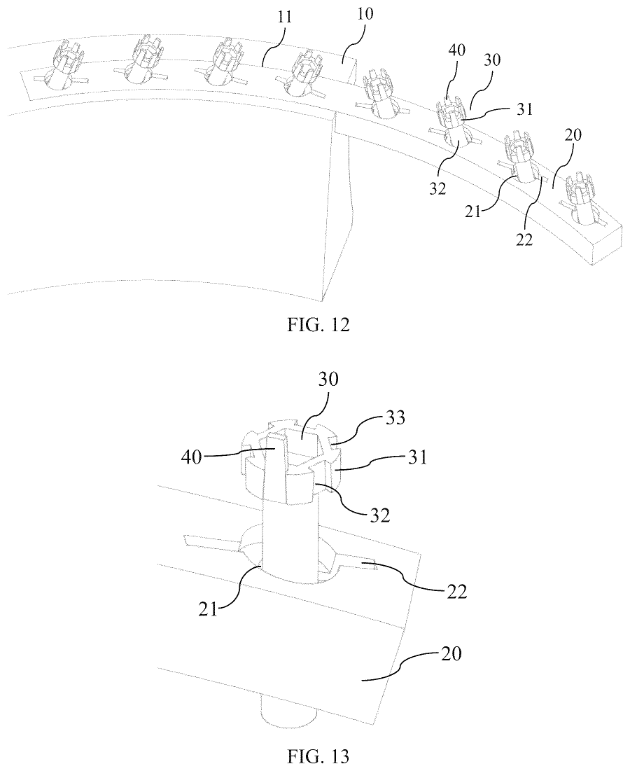

In order to prevent the bolt 30 from loosening and thereby affecting the installation and operation of the inner ring 1 after the inner ring sections 10 of the inner ring 1 are assembled, a locking structure may be further provided according to the present application. FIG. 11 is a schematic view of a locking pin according to some embodiments of the present application. FIG. 12 is a schematic view of a part of an inner ring according to some embodiments of the present application. FIG. 13 is a schematic view of a bolt and a locking pin according to some embodiments of the present application.

According to some embodiments of the present application, the inner ring 1 further includes a locking pin 40. The locking pin 40 is configured to be connected to the bolt 30 so as to limit the rotation of the bolt 30. In some embodiments, the locking pin 40 is configured to be detachably connected to the bolt 30.

In an exemplary embodiment, the bolt 30 includes a mounting groove 33 configured to connect the locking pin 40. In some embodiments, the mounting groove 33 is formed on the head 31 of the bolt 30, and extends in the axial direction of the bolt 30. The locking pin 40 may be configured to be detachably connected to the mounting groove 33 of the bolt 30. In an exemplary embodiment, the locking pin 40 is wedge-shaped, and the mounting groove 33 is wedge-shaped to match with the locking pin 40, which is to say that the mounting groove 33 is tapered in the direction away from the stem portion 32. The wedge-shaped mounting groove 33 can prevent the locking pin 40 from moving away from the connecting piece 20 in the axial direction of the bolt 30.

In an exemplary embodiment, the connecting piece 20 includes a locking groove 22 for partially receiving the locking pin 40. The locking groove 22 of the connecting piece 20 is communicated with the through hole 21 thereof. It should be noted that only two locking grooves 22 are illustratively shown in the figures. However, the present application is not limited thereto. The number of the locking grooves 22 may be determined as required.

During installation, the locking pin 40 may be inserted into the mounting groove 33 from underneath the head 31 of the bolt 30, and extend out of the upper opening of the mounting groove 33. Then, the bolt 30 connected with the locking pin 40 may be inserted into the through hole 21 of the connecting piece 20 and the fixing hole 12 of the inner ring section 10. In this way, the locking pin 40 and the head 31 of the bolt 30 are together inserted into the through hole 21 of the connecting piece 20. After the bolt 30 is screwed into place, the locking pin 40 may be bent and at least partially received in the locking groove 22 of the connecting piece 20. After the installation is completed, if a part of the locking pin 40 protrudes from the connecting piece 20, it may be removed by grinding, for example. During disassembly, the bent locking pin 40 may be straightened, and thus the bolt 30 may be unscrewed so that the inner ring section 10 and the connecting piece 20 may be separated from each other.

The inner ring 2 as described above includes two inner ring sections 10. However, the present application is not limited thereto. According to other embodiments of the present application, the inner ring 2 may include three or more inner ring sections, which may be assembled into a ring.

The connecting portion of the inner ring section 10 as described above is implemented as a connecting groove. However, the present application is not limited thereto. According to other embodiments of the present application, the connecting portion of the inner ring section 10 may be implemented as a flat plane, a protrusion, etc., and the fixing hole 12 may extend from the connecting portion of the inner ring section 10.

The multiple fixing holes 12 described above are evenly spaced apart. However, the present application is not limited thereto. In some embodiments, the multiple fixing holes 12 may be distributed at non-uniform intervals.

The present application has been described above by means of the exemplary embodiments. However, it shall be noted that the present application is not limited to the construction and method in the above embodiments. Instead, the present application is intended to cover various modifications and equivalent configurations. Furthermore, although the various elements and process steps disclosed in the present application are shown in various exemplary combinations and constructions, other combinations including more or fewer elements or processes also fall within the scope of the present application.

### LIST OF REFERENCE NUMERALS

1 inner ring;
2 outer ring;
3 rolling element;
10 inner ring section;
11 connecting groove;
12 fixing hole;
20 connecting piece;
21 through hole;
22 locking groove;
30 bolt;
31 head;
32 stem portion;
33 mounting groove;
40 locking pin.

1. A bearing ring, comprising:
a plurality of bearing ring sections configured to be connected into a ring, wherein each bearing ring section comprises: connecting portions located on an axial end surface of the bearing ring section and adjacent to circumferential end surfaces of the bearing ring section; and at least one fixing hole located at each connecting portion and extending from the connecting portion;
a plurality of connecting pieces, wherein each connecting piece comprises a plurality of through holes; and
a plurality of bolts, wherein
each connecting piece is configured to be arranged on the adjacent connecting portions of two adjacent bearing ring sections when the plurality of bearing ring sections are assembled, so that the plurality of through holes of the connecting piece correspond to the fixing holes of the two adjacent bearing ring sections; each through hole and the corresponding fixing hole extend obliquely with respect to an axial direction of the bearing ring, and each bolt is configured to be inserted into one through hole of the connecting piece and the corresponding fixing hole of the bearing ring sections, thereby connecting the plurality of bearing ring sections to each other.

2. The bearing ring according to claim 1, wherein each connecting portion of each bearing ring section is implemented as a connecting groove recessed from the axial end surface of the bearing ring section, and
wherein each connecting piece is configured to be arranged in the contiguous connecting grooves of the two adjacent bearing ring sections.

3. The bearing ring according to claim 2, wherein each fixing hole of the bearing ring section is configured to extend obliquely from the corresponding connecting groove in a direction taking it gradually away from the corresponding circumferential end surface of the bearing ring section.

4. The bearing ring according to claim 3, wherein each connecting groove of the bearing ring section is arc-shaped, and each connecting piece is arc-shaped.

5. The bearing ring according to claim 4, further comprising a locking pin configured to be connected to the bolt, wherein the connecting piece comprises a locking groove communicated with the through hole thereof, and the locking pin is configured such that, when the bolt connected with the locking pin is inserted into one through hole of the connecting piece and the corresponding fixing holes of the bearing ring sections, at least one locking pin is bent and at least partially received in the locking groove of the connecting piece.

6. The bearing ring according to claim 5, wherein the bolt comprises a mounting groove located on a head of the bolt and extending in an axial direction of the bolt, and the locking pin is configured to be detachably connected in the mounting groove of the bolt.

7. The bearing ring according to claim 6, wherein the mounting groove and the locking pin have wedge shapes matched with each other, and the wedge shape of the mounting groove is configured to prevent the locking pin from moving away from the connecting piece in the axial direction of the bolt.

8. The bearing ring according to claim 1, wherein the bearing ring comprises two bearing ring sections and two connecting pieces.

9. A rolling bearing, comprising the bearing ring according to claim 1.

10. The rolling bearing according to claim 9, wherein the bearing ring is an inner ring of the rolling bearing.

11. A bearing ring comprising:
a plurality of bearing ring sections configured to connect into a ring, wherein each bearing ring section comprises: connecting portions located on an axial end surface of the bearing ring section and adjacent to circumferential end surfaces of the bearing ring section; and at least one fixing hole located at each connecting portion and extending from the connecting portion;
a plurality of connecting pieces, wherein each connecting piece comprises a plurality of through holes; and
a plurality of bolts, wherein each connecting piece is configured to be arranged on the adjacent connecting portions of two adjacent bearing ring sections when the plurality of bearing ring sections are assembled, so that the plurality of through holes of the connecting piece correspond to the fixing holes of the two adjacent bearing ring sections; each through hole and the corresponding fixing hole extend obliquely with respect to an axial direction of the bearing ring, and each bolt is configured to insert into one through hole of the connecting piece and the corresponding fixing hole of the bearing ring sections to connect the plurality of bearing ring sections to each other;
wherein each connecting portion of each bearing ring section is implemented as a connecting groove recessed from the axial end surface of the bearing ring section; and
wherein each connecting piece is configured to be arranged in the contiguous connecting grooves of the two adjacent bearing ring sections.

12. The bearing ring according to claim 11, wherein each fixing hole of the bearing ring section is configured to extend obliquely from the corresponding connecting groove in a direction taking it gradually away from the corresponding circumferential end surface of the bearing ring section.

13. The bearing ring according to claim 12, wherein each connecting groove of the bearing ring section is arc-shaped, and each connecting piece is arc-shaped.

14. The bearing ring according to claim 13, further comprising a locking pin configured to be connected to the bolt, wherein the connecting piece comprises a locking groove communicated with the through hole thereof, and the locking pin is configured such that, when the bolt connected with the locking pin is inserted into one through hole of the connecting piece and the corresponding fixing holes of the bearing ring sections, at least one locking pin is bent and at least partially received in the locking groove of the connecting piece.

15. The bearing ring according to claim 14, wherein the bolt comprises a mounting groove located on a head of the bolt and extending in an axial direction of the bolt, and the locking pin is configured to be detachably connected in the mounting groove of the bolt.

16. The bearing ring according to claim 15, wherein the mounting groove and the locking pin have wedge shapes matched with each other, and the wedge shape of the mounting groove is configured to prevent the locking pin from moving away from the connecting piece in the axial direction of the bolt.

17. The bearing ring according to claim 11, wherein the bearing ring comprises two bearing ring sections and two connecting pieces.

18. A roller bearing comprising:
an inner ring; and
an outer ring,
wherein at least one of the inner ring or the outer ring comprises:
a plurality of bearing ring sections configured to connect into a ring, wherein each bearing ring section comprises: connecting portions located on an axial end surface of the bearing ring section and adjacent to circumferential end surfaces of the bearing ring section; and at least one fixing hole located at each connecting portion and extending from the connecting portion;
a plurality of connecting pieces, wherein each connecting piece comprises a plurality of through holes; and
a plurality of bolts, wherein each connecting piece is configured to be arranged on the adjacent connecting portions of two adjacent bearing ring sections when the plurality of bearing ring sections are assembled, so that the plurality of through holes of the connecting piece correspond to the fixing holes of the two adjacent bearing ring sections; each through hole and the corresponding fixing hole extend obliquely with respect to an axial direction of the bearing ring, and each bolt is configured to insert into one through hole of the connecting piece and the corresponding fixing hole of the bearing ring sections to connect the plurality of bearing ring sections to each other.

19. The rolling bearing according to claim 18, wherein each connecting portion of each bearing ring section is implemented as a connecting groove recessed from the axial end surface of the bearing ring section; and
wherein each connecting piece is configured to be arranged in the contiguous connecting grooves of the two adjacent bearing ring sections.

20. The bearing ring according to claim 18, wherein at least one of the inner ring or the outer ring comprises two bearing ring sections and two connecting pieces.
